(19) United States
(12) Patent Application Publication
(10) Pub. No.: US 2012/0186760 A1
(43) Pub. Date: Jul. 26, 2012

(54) Quick operational vehicle shading device

(76) Inventor: Pengchong Li, San Gabriel, CA (US)

(21) Appl. No.: 12/931,023

(22) Filed: Jan. 21, 2011

(51) Int. Cl. B60J 11/04

(52) U.S. Cl. 160/372

(57) ABSTRACT

A quick operational vehicle shading device comprises a net-like supporting structure that is structured by a group of tubular elements and connectors; the tubular elements connected to each other by a group of spring-connections, and an awning supported by the net-like supporting structure. These spring-connections make this supporting structure collapsible and could be back to shape quickly, and the tension from the spring-connections support the net-like supporting structure to stretch out the awning. The quick operational vehicle shading device covers the entire top part of vehicle, to protect vehicle from sun exposure.

### CROSS-REFERENCE TO RELATED APPLICATIONS

The prior filed nonprovisional utility patents with application Ser. Nos. 12/924,477 and 12/927,435 have similar functions of this present invention.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates to a quick operational vehicle shading device, it can be easily opened to shelter the entire top part of vehicle to prevent direct sunlight and heat from entering into the vehicle, and folded into a convenient unit for storage.

### BACKGROUND OF THE INVENTION

The heat-related problems are annoying to most people who parks vehicle in an uncovered parking lot or parking space for a while, especially for people who live in hot place with direct sunshine.

The more important issue is it will harm human health. The vehicle interiors trim will emit some chemical after the vehicle exposes to direct sunlight for a period of time. And direct sunlight will also increase the speed of wear and tear of the vehicle interior trims. Also the heated interiors surfaces would burn people skin, because people usually wear short sleeves, short pants, skirts or some shear clothes, their less protected skin will easily feel the hot sensation from heated interiors surfaces, and will also get burned easily.

The common vehicle shading products in the current market do have some disadvantages. Most of them only can provide shading for windows, but do not protect the roof or vehicle body. The heat can get into the interior of vehicle through window as well as through the roof and vehicle body. The vehicle body absorbs heat from heat radiation due to exposure to sunlight.

### SUMMARY OF THE PRESENT INVENTION

One objective of the present invention is to provide quick operational and portable vehicle shading device that shelters the entire top of the vehicle body, to effectively prevent the heat radiation rise the temperature of interior of the vehicle.

The present invention is to provide a quick operational vehicle shading device that can be folded and stored into a convenient carrying unit, and quickly opened to shelter vehicle in a few seconds.

Second objective of the present invention is this vehicle shading device has a net-like supporting structure that is structured by many small tubular elements, and the supporting structure could be built to different geometric shapes upon design desire.

Third Objective of the present invention is the tubular elements are connected by a group of spring-connections, to build the net-like supporting structure. Since the spring-connection can be collapsed and return to original position, the supporting structure shares the same property, therefore the quick operational vehicle shading device of the present invention can be folded for storage and return to open position by itself quickly to shelter vehicle.

### BRIEF DESCRIPTION OF THE DRAWINGS

FIG. 1 is perspective view of the quick operational vehicle shading device of the present invention sheltering a vehicle

FIG. 2 is perspective view of one possible geometric shape of supporting structure of the present invention

FIG. 3 is perspective view of another possible geometric shape of supporting structure of the present invention

FIG. 4 is perspective view of assembled cross-connection with tubular elements

FIG. 5 is perspective view of assembled Y-connection with tubular elements

FIG. 6 is perspective exploded view of cross-connection with tubular elements

FIG. 7 is perspective exploded view of Y-connection with tubular elements

FIG. 8 is perspective view of cross-connection in folded position

FIG. 9 is perspective view of Y-connection in folded position

FIG. 10 is perspective view of assembled tubular elements

FIG. 11 is perspective exploded view of the tubular elements

FIG. 12 is perspective view of tubular elements in folding position

FIG. 13 is perspective view of the spring-connection

FIG. 14 is perspective exploded view of the spring-connection

FIG. 15 is perspective view of the spring-connection in folding position

### DETAIL DESCRIPTION OF PREFERRED EMBODIMENT

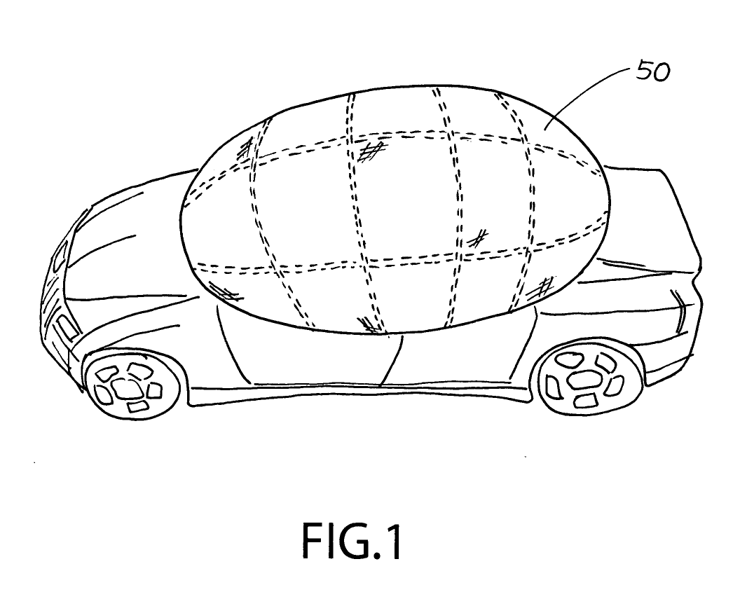

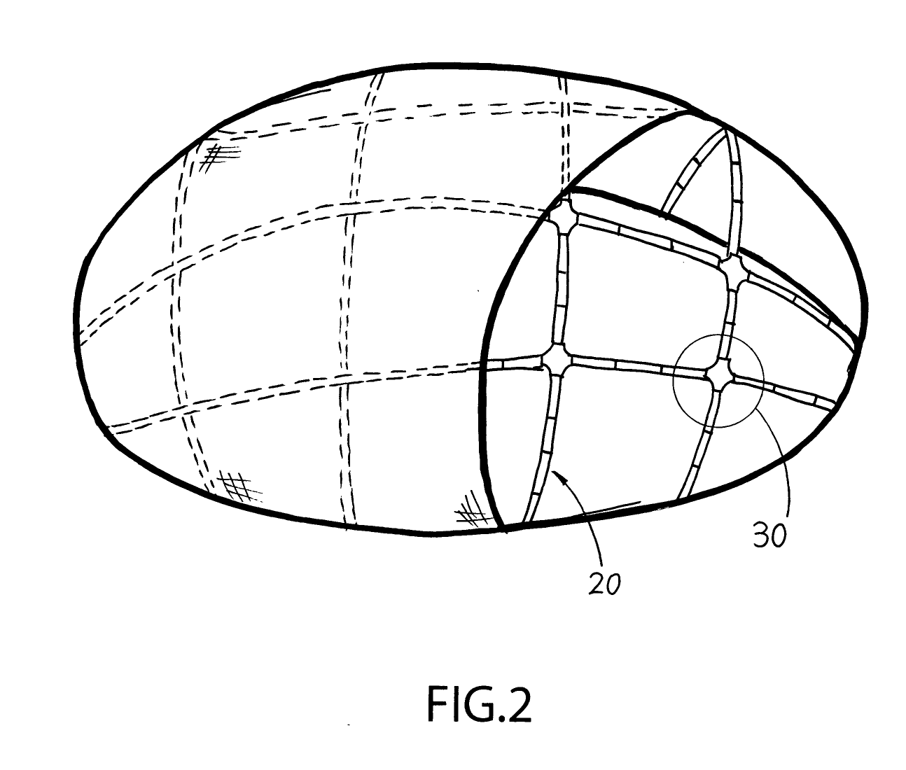

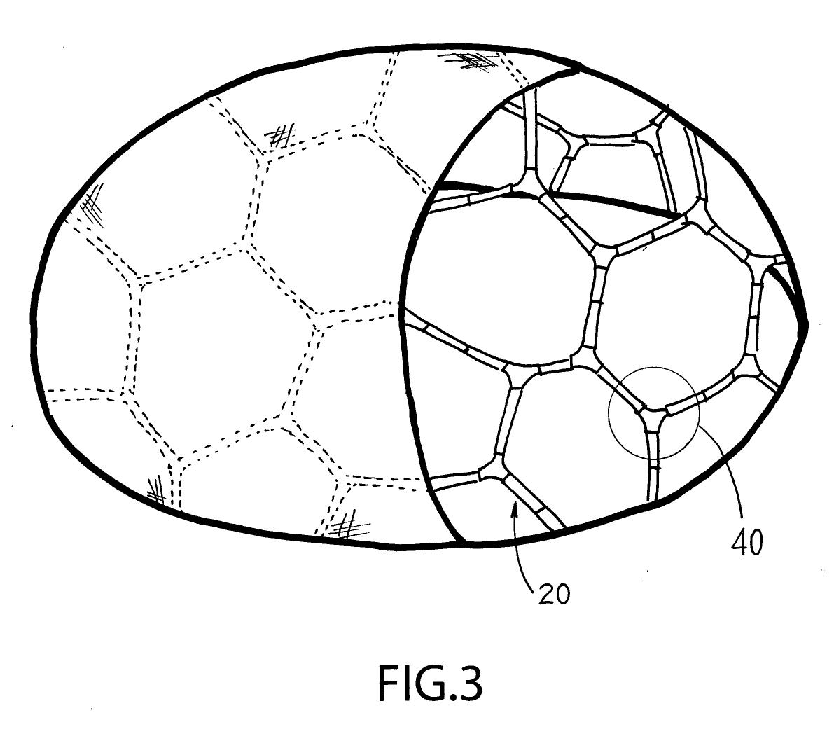

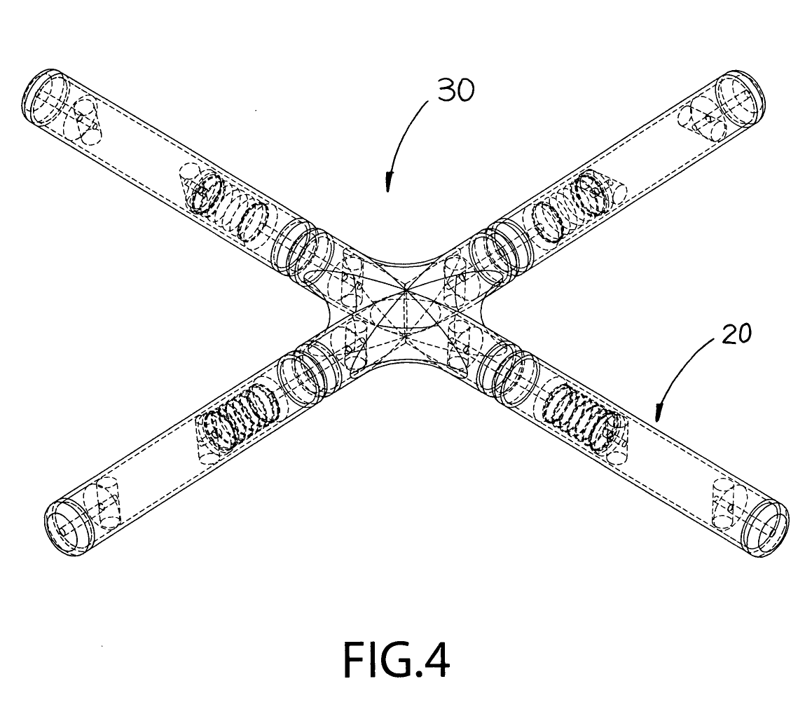

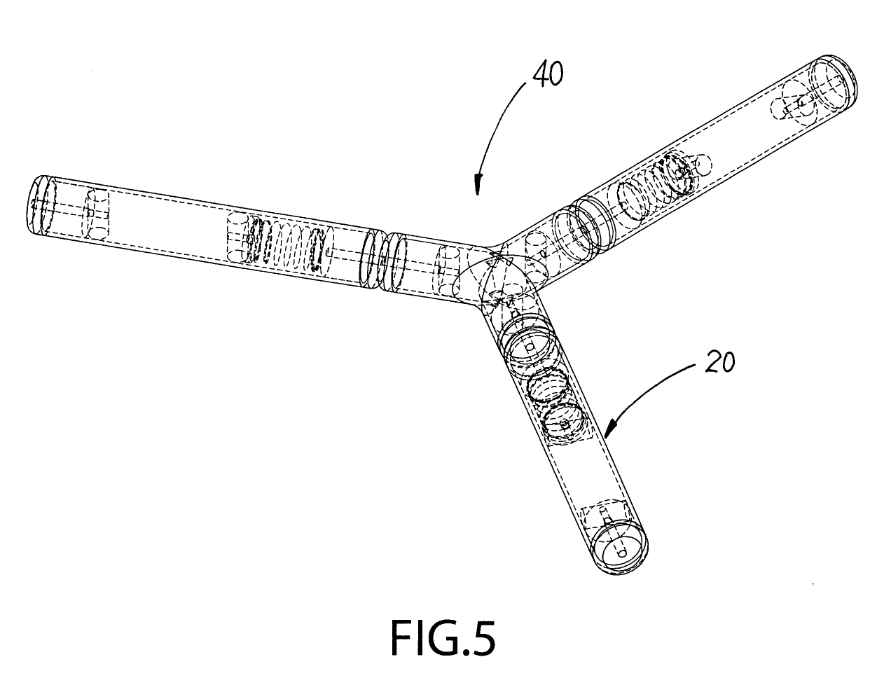

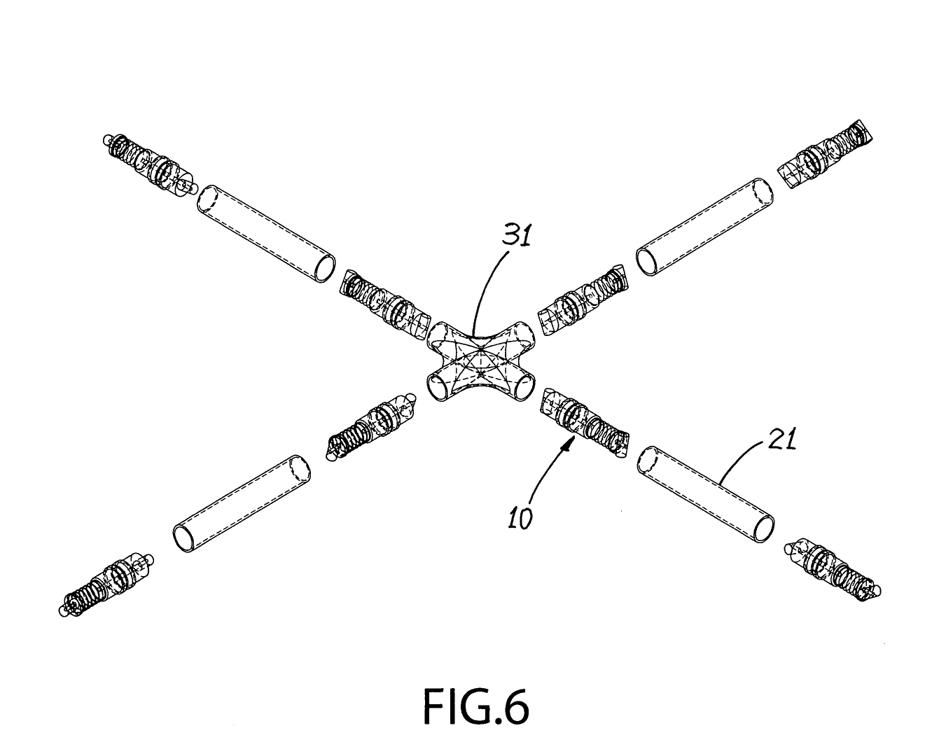

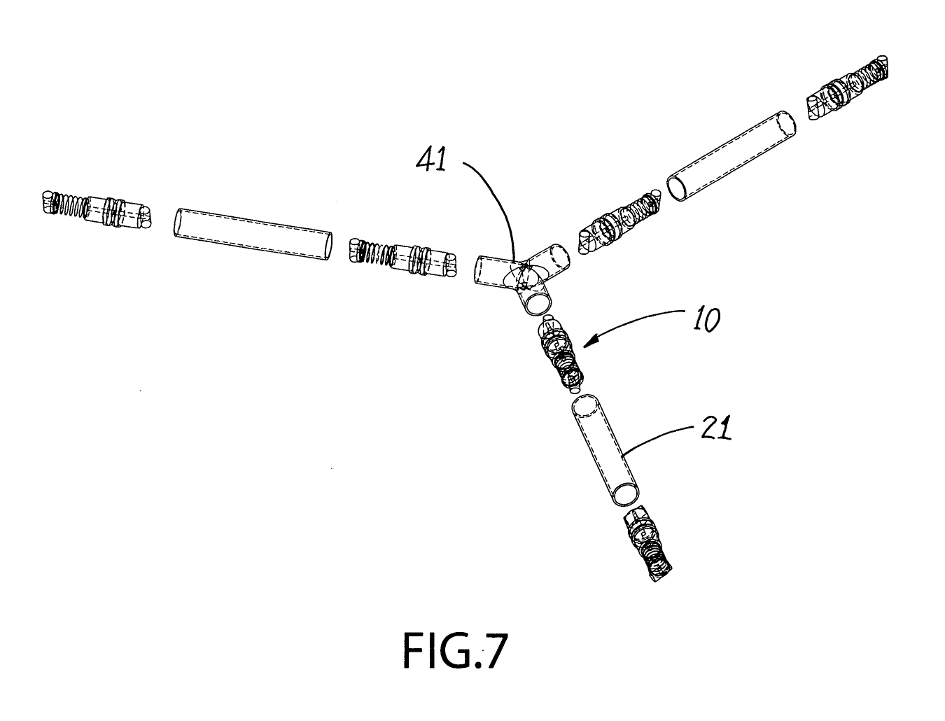

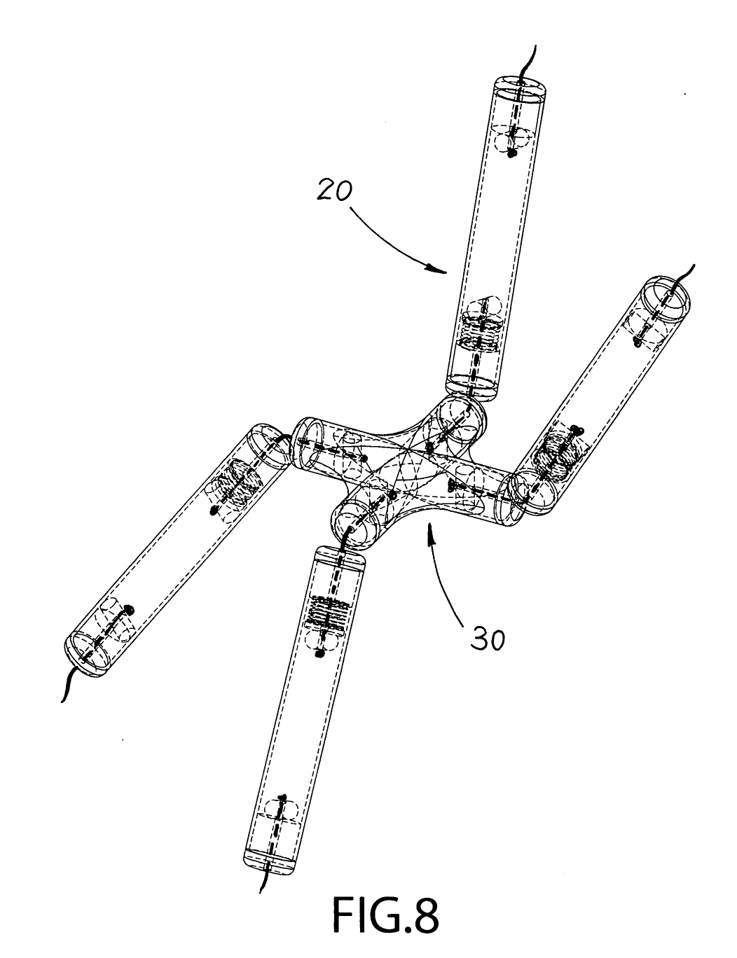

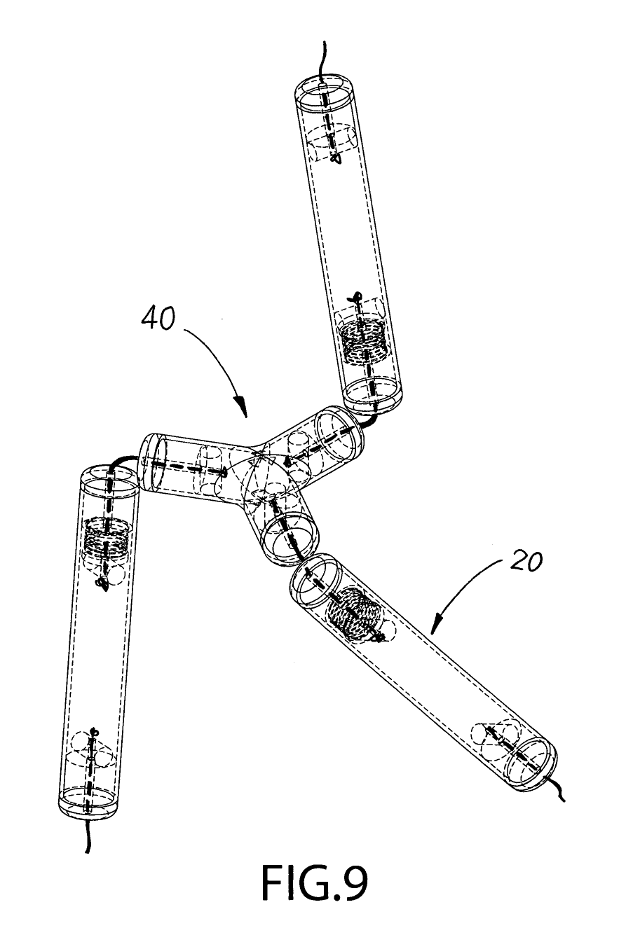

As shown in FIG. 1, the quick operational vehicle shading device of the present invention is sheltering a vehicle. The sheltering awning 50 coves top portion of vehicle includes roof and windows, to effectively protect the vehicle from direct sun exposure. The awning 50 is supported by a net-like supporting structure that is built by a group of tubular elements 20 as show in FIG. 2 and FIG. 3, and the awning is also secured onto the net-like supporting structure. The tubular elements 20 and multiple-way connections such as cross-connections 30 and Y-connections 40 connect to each other in different patterns to form different geometric structures, which are then connected to form the net-like supporting structure as shown in FIG. 2 and FIG. 3. The cross-connections 30 and tubular elements 20 connect to each other form rectangular shapes, and the Y-connections 40 and tubular elements 20 connect to each other form hexagon shapes. The enlarged views of cross-connection 30 and Y-connection 40 are shown in FIG. 4 and FIG. 5. Each cross-connection 30 comprises a cross-connector 31, a group of spring-connections 10, and a group of small tubes 21 as shown in FIG. 6. The cross-connector 31 has tubular receiving cavity at its four ends, and the end of spring-connection 10 without spring spliced into the tubular receiving cavity, the other end of spring-connection spliced into the small tube 21, and another spring-connection 10 could be spliced into the empty end of the same small tube 21, in order connect two tubular elements together. And this process could be repeated to reach desire length. Each Y-connection 40 comprises a Y-connector 41, a group of spring-connections 10, and a group of slim tubes 21 as shown in FIG. 7. The Y-connection 40 is assembled similarly to cross-connection as described above. Because the Y-connection 40 and cross-connection 30 have spring-connections, they could be collapsed at each spring-connection as shown in FIG. 8 and FIG. 9, and return to original shape by themselves.

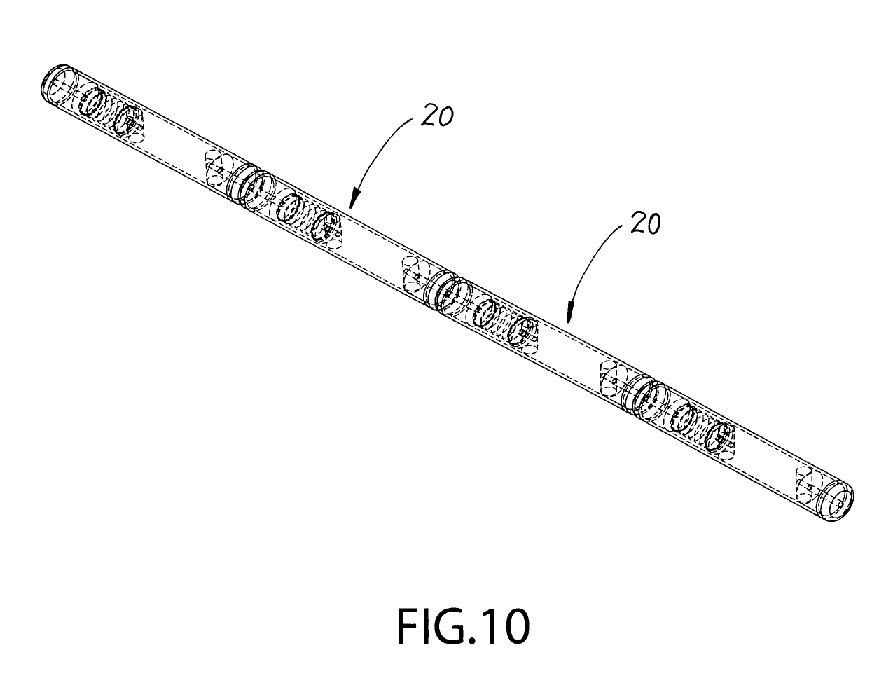

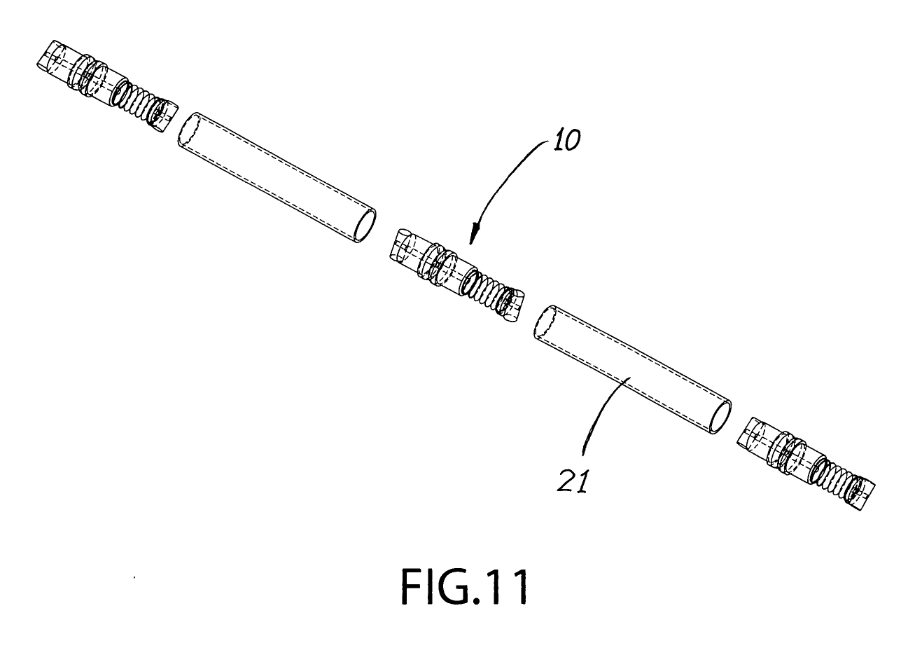

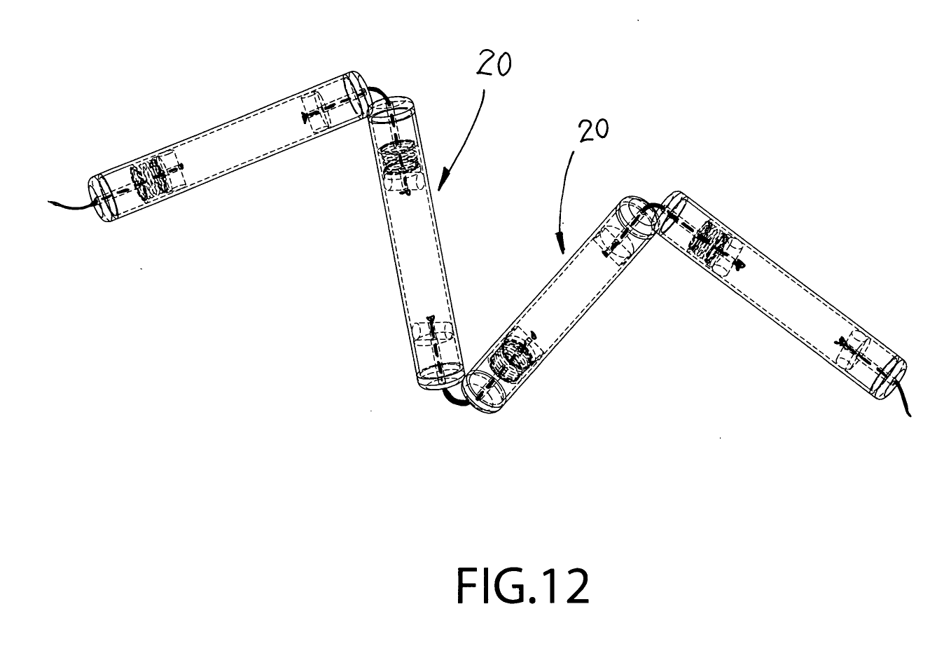

The small tubes 21 cover each end of spring connection 10 as shown in FIG. 11 to build the tubular elements 20 as shown in FIG. 10 also as shown in FIG. 2 and FIG. 3 of the supporting structure. Repeat this process until reach the desire length, therefore, the size of the supporting structure is adjustable, could meet different design desires and requirements. Each tubular element 20 could be pulled apart from each other as shown in FIG. 12, and back together as shown in FIG. 10, because the spring-connection 10 provide the retractability to them.

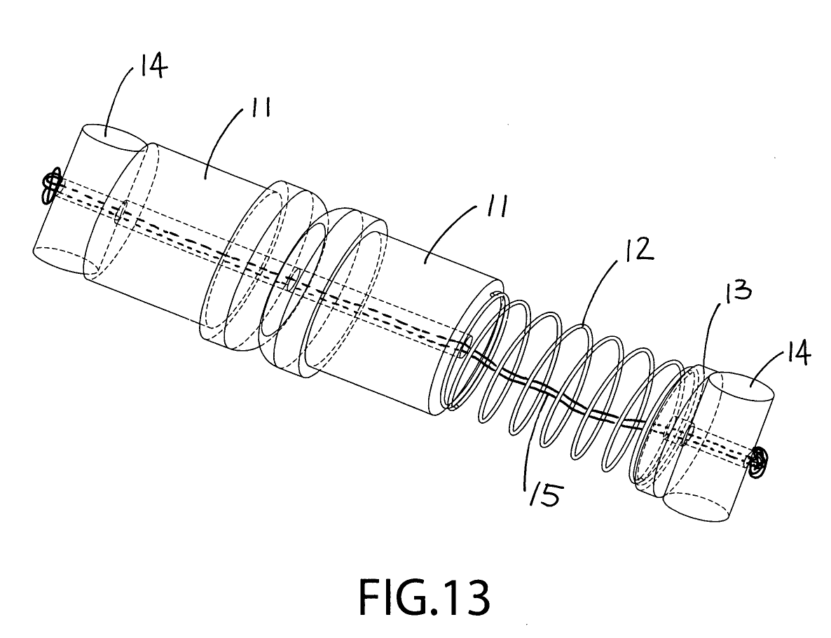

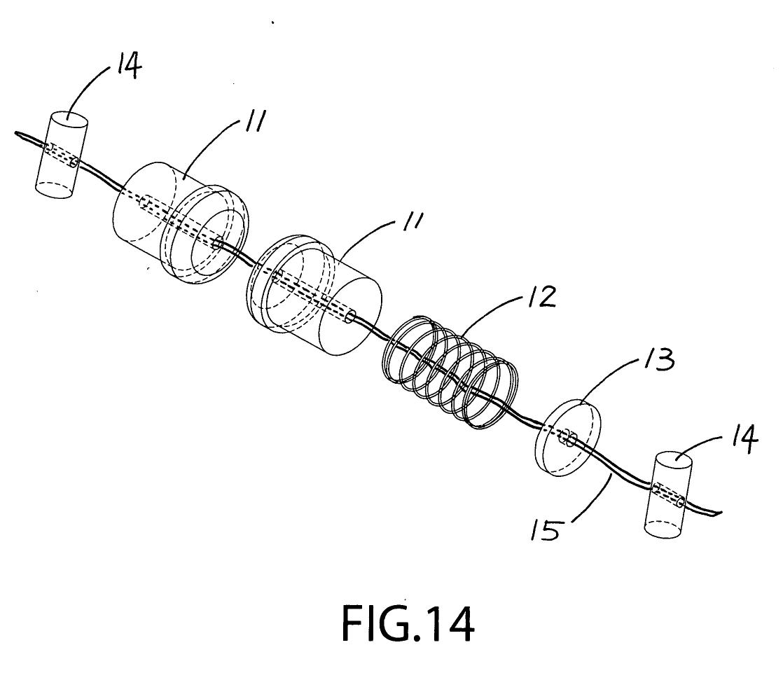

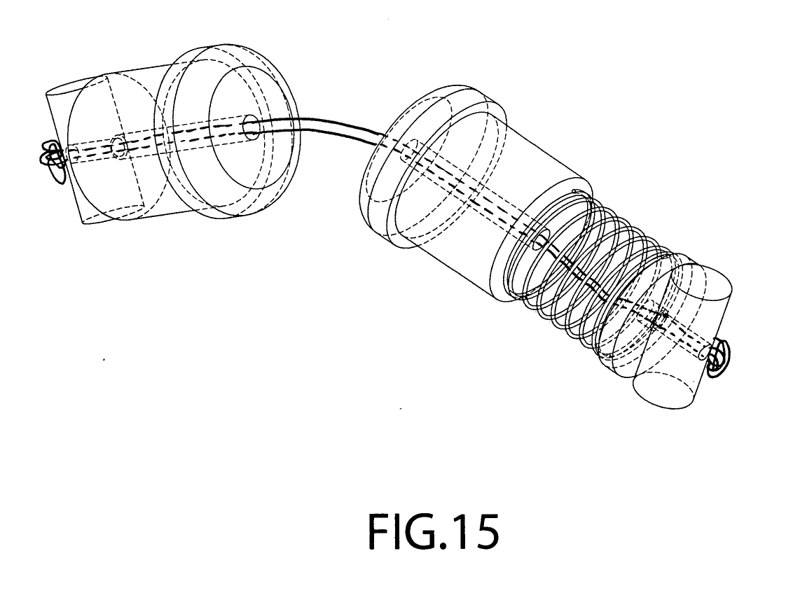

The spring-connection 10 spliced into the tubular elements 20, Y-connector 41, and cross-connector 31 to connect them together, and provide the co llapsibility and property of return to original shape to the supporting structure. As shown in FIG. 13 and FIG. 14, the spring-connection 10 simply comprises two tube-plugs 11, two cylindrical stoppers 14, a compression spring 12, a washer 13, and a soft wire 15. Each part assembled together sequentially as shown in FIG. 14, the tube-plug 11, cylindrical stopper 14, and a washer 13 all have a through hole in middle of their bodies, the soft wire 15 goes through each part and secured on to each cylindrical stopper 14, to build the spring-connection 10 as shown in FIG. 13. The two tube-plugs 11 could be pulled apart as shown in FIG. 15, and the compression spring 12 is compressed, when release the pulling force, the spring force will bring the two tube-plugs 11 back together. This process allows the whole supporting structure to be collapsible, and be able to return to open position. Therefore, the spring-connection 10 is the main part of this present invention. The spring-connections 10 connect tubular elements 20. Y-connections 40, and cross-connections 30 together to build the whole net-like supporting structure, and each spring-connection 10 is an independent folding point, allows the supporting structure to be folded at each spring-connection. Because the retractability of the spring-connection 10, the collapsed supporting structure could be back to original shape by itself. And also the spring-connections 10 provide tensile force to the each element of the supporting structure; therefore the net-like supporting structure could support and tensionally stretch out the awning 50 to shelter vehicle.

Therefore, the present invention of quick operational vehicle shading device is easy operational and convenient. To open this quick operational vehicle shading device, the user just simply take it out from its convenient carrying unit, and put it on top of a vehicle, then release it, the quick operational vehicle shading device will shape itself to sheltering position as shown in FIG. 1 in a few seconds. After using it, the user could remove it from the vehicle and fold it in arbitrary ways by their preferences, and then put the folded quick operational vehicle shading device into the convenient unit for storage or carrying.

What is claimed is:

1. A quick operational vehicle shading device comprising: a net-like supporting structure that is structured by a group of tubular elements and multiple-way connectors; the tubular elements and connectors connected to each other by a group of spring-connections, and a shading awning supported by said net-like supporting structure. The tubular elements and multiple-way connectors connect to each other in different patterns to form different geometric structures, which are then connected to form the net-like supporting structure.

2. A quick operational vehicle shading device as recited in claim 1, has spring-connections on the net-like supporting structure. Wherein said the spring-connection, has retractablility and shares this property with the net-like supporting structure. The spring-connection comprises a soft wire connecting two tube-plugs, and a compression spring by going through each part sequentially, and the soft wire secured on a stopper at each end.

3. A quick operational vehicle shading device as recited in claim 1, is quick operational, could be opened in a few seconds by placing it on top of a vehicle and release it, it will form its shape in sheltering position by itself; and folded in arbitrary ways. The folded quick operational vehicle shading device could be stored into a convenient unit for carrying or storage.
